(19) United States
(12) Patent Application Publication
(10) Pub. No.: US 2003/0225352 A1
(43) Pub. Date: Dec. 4, 2003

(54) Container with integrated massage device

(75) Inventors: Lorenz Eckers, Tostedt (DE); Bernhard Felten, Pinneberg (DE); Holger Pries, Leer (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Beiersdorf AG

(21) Appl. No.: 10/402,127

(22) Filed: Mar. 28, 2003

Related U.S. Application Data
(63) Continuation of application No. PCT/EP01/11100, filed on Sep. 26, 2001.

(30) Foreign Application Priority Data
Sep. 29, 2000 (DE) 100 48 757.2

(51) Int. Cl. A61H 7/00

(52) U.S. Cl. 601/137

(57) ABSTRACT

A container for storing a product, such as a liquid, flowable formulation, paste, or powder. The container comprises a container body that includes an integrated massage device. The massage device comprises at least one rotatable device that is partially disposed within a seating in the exterior surface of the container body. This rotatable device is mounted so that at least a portion of the rotatable device protrudes from the container body, and so that the rotatable device may rotate (e.g., about an axis of rotation) relative to the container body. The rotatable devices may be used to massage a product into a a user's skin after the product has been dispensed from the container onto the user's skin.

### CROSS-REFERENCE TO RELATED APPLICATIONS

This is a continuation application of PCT/EP01/11100, filed Sep. 26, 2001, which is incorporated herein by reference in its entirety, and also claims the benefit of German Priority Application No. 100 48 757.2, filed Sep. 29, 2000.

### FIELD OF THE INVENTION

The invention relates to a container for liquids, flowable formulations, pastes, powders, and the like, that includes a container body with a massage device comprising at least one rotatable device held within the body, and also to the use of the container.

### BACKGROUND OF THE INVENTION

Containers, such as bottles and jars, serve as storage for liquids in the cosmetic and dermatological sector. The bottles here have in particular been manufactured from flexible plastic, and slight pressure on the body of the bottle is therefore sufficient to expel liquid present in the bottle from the aperture. By way of example, mention may be made here of the known plastics bottles for shower preparations, liquid soaps, and shampoos, this list not being intended to be complete. Preference is given to bottles which can be closed using a screw-fit lid. The bottles or containers are often produced by extrusion blow molding.

U.S. Pat. No. 3,892,829 discloses a process and a device for producing flat bottles from an extruded tube, which is preblown in an intermediate mold before being passed to a final blowing mold, the mold cavity of which has the profile of the flat bottle to be produced.

DE 37 02 844 A1 discloses a process which follows this principle, and an extrusion blow molding machine which operates accordingly. Here, a plastics tube is freely extruded and passed to an intermediate mold, where it is blown to give an intermediate molding with rotational symmetry. This intermediate molding, whose cross section at every point along its axis is therefore circular, has by this stage approximately the length (height) of the flat bottle to be produced, and its main sections (base, body, neck) have a circumference which approximates to a greater or lesser extent to the corresponding circumferences of the flat bottle. The latter is finally molded by passing the intermediate molding into the type of final blowing mold known by way of example from DE 27 20 448 C2. This is a proven method for producing flat bottles with substantially uniform wall thickness with minimal waste and therefore minimal pinch-off weld.

EP 0 688 658 A1 provides (mechanical) support from below to the intermediate molding, at least during transfer from the intermediate mold to the final blowing mold. At least during transfer from the intermediate mold to the final blowing mold, an additional, movable mold section is used to buttress the intermediate molding. This mold section may advantageously have been adapted to the base profile of the intermediate molding. The mold section generally has to be able to move vertically in order not to hinder the closing of the final blowing mold.

Typically, when dispensing a lotion or other healthcare or cosmetic product from the prior art containers discussed above, a user typically squeezes the product out of the container and then massages the product, by hand, into the desired area. For example, when dispensing lotion onto their left arm, a user would first squeeze a small amount of lotion into the palm of their right hand and then use their right hand to massage the lotion into the skin on their right arm.

One problem associated with this prior art method of applying a product to skin is that it requires the user to manage both the product's container and any applicator (e.g., a towel, or simply the user's free hand) to be used in applying the product to the user's skin. Accordingly, there is a need for an apparatus and method that allows a user to dispense and apply a product without having to simultaneously manage both a container and an applicator.

### SUMMARY OF THE INVENTION

The present invention provides an apparatus and method that allows a user to dispense and apply a product without having to simultaneously manage both a container and an applicator.

More particularly, a container according to one embodiment of the invention comprises a container body defining: (A) a seating for receiving at least a portion of a rotatable device; (B) a product storage portion that is configured for receiving a product to be stored within the container; and (C) a neck type extension for dispensing the product from the container. The container also includes a rotatable device that is disposed at least partially within the seating so that a first portion of the rotatable device is within the seating, and so that a second portion of the rotatable device extends outside of the seating. The rotatable device is mounted to rotate relative to the container body.

In one embodiment of the invention, the container comprises a plurality of rotatable devices. In yet another embodiment of the invention, one or more of the rotatable devices is mounted to rotate about at least one axis of rotation. In a further embodiment of the invention, the exterior surface of at least one of the rotatable devices defines a symmetrical arrangement of depressions.

In a further embodiment of the invention, at least one of the rotatable devices is spherical. In another embodiment of the invention, at least one of the rotatable devices comprises a roller.

In one embodiment of the invention, the container body is configured to receive the rotatable device into the seating and to hold the rotatable device in place in a “snap fit” manner.

A container according to a further embodiment of the invention comprises a container body defining both a seating for receiving at least a portion of a rotatable device, and a product storage portion that is configured for receiving a product to be stored within the container. A rotatable device is disposed at least partially within the seating so that a first portion of the rotatable device is within the seating, and so that a second portion of the rotatable device extends outside of the seating. In one embodiment of the invention, the rotatable device is mounted to rotate relative to the container body about an axis of rotation.

A method of dispensing and applying a product according to one embodiment of the invention comprises the steps of: (1) providing a container that is filled at least partially with the product and that comprises at least one rotatable device that is disposed adjacent an exterior surface of the container, the container comprising a neck type extension for dispensing the product from the container; (2) dispensing a portion of the product from the outlet onto a user's skin; and (3) using the at least one rotatable device to distribute the product relative to the user's skin.

A method of dispensing and applying a product according to another embodiment of the invention comprises the steps of: (1) providing a container that is filled at least partially with the product and that comprises at least one rotatable device that is disposed adjacent an exterior surface of the container, the rotatable device being configured to rotate about an axis of rotation; (2) dispensing a portion of the product from the container onto a user's skin; and (3) using the at least one rotatable device to distribute the product relative to the user's skin. In one embodiment of the invention, the step of using the at least one rotatable device to distribute the product comprises causing the at least one rotatable device to rotate about the axis of rotation.

### BRIEF DESCRIPTION OF THE DRAWINGS

Having thus described the invention in general terms, reference will now be made to the accompanying drawings, which are not necessarily drawn to scale, and wherein:

FIG. 1 shows the front view of a particularly advantageously designed container in bottle form with a number of devices which together form the massage equipment.

FIG. 2 shows the side view of the particularly advantageously designed container in bottle form with a number of devices.

FIG. 3 shows a plan view of the particularly advantageously designed container in bottle form with a number of devices.

FIG. 4 depicts a container according to one embodiment of the invention.

FIG. 5 depicts a container according to another embodiment of the invention.

FIG. 6 depicts a container according to yet another embodiment of the invention.

FIG. 7 depicts a container according to a further embodiment of the invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Surprisingly, this object has been achieved by way of a container as described in independent claim 1. The various other claims provide further advantageous embodiments of this container. A method of using this container is also claimed.

The invention therefore provides a container for liquids, flowable formulations, pastes, powders, and the like, including a container body with a massage device comprising at least one rotatable device held within the body, and held within the body in such a way that at least part of the surface of the device protrudes from the body.

In a first advantageous embodiment, the device is held in a mounting which is formed from a seating which has been adapted to the shape of the rotatable device in such a way that the rotatable device has been fitted within the seating in such a way that part thereof protrudes from the seating. In another preferred embodiment, the device has also been mounted on at least one axis of rotation.

Another preferred container has two or more devices present, in particular arranged in a geometric pattern. The patterns may be composed of a regular arrangement of the devices on the container, and by way of example, therefore, the separations between the individual devices may be regular. The nature of the pattern to be selected may depend on the nature of the application sector for the container, and also on its contents. In a first embodiment of this device, it comprises a rotatable body, in particular of a geometric body with rotational symmetry.

The device may be composed of metal, glass, ceramics, porcelain, or of a suitable plastic. It is very advantageous for the material used to comprise polypropylene. Materials with excellent suitability are generally thermoplastics, elastomers, or combinations of plastics from these groups. Their properties can be varied widely by adding plasticizers, fillers, stabilizers, and other additives, and also by fiber-reinforcement. Examples which may be mentioned of thermoplastics and elastomers are: all of the plastics composed of linear polymer molecules or of polymer molecules cross linked in a thermally labile manner, examples being polyolefins, vinyl polymers, polyamides, polyesters, polyacetals, polycarbonates, and also some polyurethanes and ionomers; TPES (styrene-oligoblock copolymers), TPEO (thermoplastic polyolefins), TPEU (thermoplastic polyurethanes), TPEE (corresponding copolyesters), TPEA (corresponding copolyamides), and natural and synthetic rubbers.

Preference is given to devices which have a structured surface. In another very advantageous embodiment, the structuring forms depressions in the surface, in particular depressions in a symmetrical arrangement. In another variant, the device has structuring by virtue of elevations located on the surface.

The depressions in the surface preferably have the form of seatinges, grooves, notches, channels, or the like. However, any depression may be utilized here without restriction to increase functionality, and examples include depressions in the form of ornamentation, designs, or characters, or the like.

For the purposes of the invention, the following two device variants are very advantageous. First, the arrangement and dimensioning of the depressions may be such that the depressions are separate from one another, for example in the case of the above mentioned seatinges if these have no contact with one another (“closed-pore”). Second, there may be connection between the depressions so that there is a “channel system” located in the macroscopic surface of the sphere (“open-pore; seen in another way, this is equivalent to the abovementioned elevations on the surface of the sphere if the “floor” of the channels is taken as the macroscopic surface of the sphere). In a further embodiment of the device, this is a sphere, an ellipsoid, or a roller, either unstructured with macroscopically smooth surfaces or likewise with the structures mentioned. Examples of other shapes with good suitability are cones, hyperboloids, paraboloids of revolution, and also sections or portions or frusta of these geometric bodies, and also irregular geometric bodies.

The mounting is preferably comprises a socket whose shape substantially envelops the shape of the device and whose internal diameter is slightly greater than the external diameter of the device (in the case of elliptical bodies, the two semiaxes being correspondingly somewhat larger than those of the device). This socket is further described below, taking a spherical device (sphere). For devices of other shapes, the shape is to be adapted to the shape of the device, and the description applies analogously.

The socket in the body of the bottle narrows slightly toward the outside in the shape of a ring so that the diameter of the remaining aperture is somewhat smaller than the diameter of the sphere. The sphere may then be inserted into the socket using slight pressure, and therefore has a “snap fit” into the socket and does not spontaneously fall out again from the socket. Part of its surface therefore protrudes from the device, and the sphere is freely rotatable in all directions, so that when the devices forming a massage device in the bottle are passed across the skin with a rolling movement, a massage effect arises.

In one variant of this socket, there is no complete ring present, but instead at least two, preferably at least three, ring sections are present to hold the sphere. The shape of these is therefore such that the sphere does not fall out after it has been snap-fitted.

In the case of a roller-shaped device, the mounting comprises two opposite walls, each terminating in a narrowing toward the other wall. In one preferred embodiment, the two side walls here are sections of a tube whose diameter is somewhat greater than the diameter of the roller. Two plane-parallel walls may close the front and rear of this tube section. Given appropriate selection of the dimensions of the surface-structured sphere, of the ellipsoid, or of the roller, the structured systems can be inserted into the known mounting systems.

In the usual embodiments of the device, this has been fitted within the mounting so as to be capable of free rotation in all spatial directions, and this is particularly applicable to the application bodies with rotational symmetry. In another advantageous embodiment, the device has also been mounted on at least one axis of rotation. This gives the mounting additional stability and moreover prevents the device from falling out of the container. This also allows the direction of rotation of the body to be prescribed, opening up additional possibilities for designing the surface geometry. This structure may either permit the axis to rotate in its axis mounting or else permit the device to rotate on the axis.

The container of the invention can be used to store liquid or flowable substances, or else readily distributable solid substances, or else mixtures of two or more components, while at the same time the massage equipment makes it easier for the substances dispensed to be massaged into the skin. The container has excellent suitability for emulsions, suspensions, dispersions, solutions (of gaseous, of liquid, or of solid substances), colloids, and the like, very preferably for applying cosmetic or dermatological compositions to the skin, in particular gels, emulsions, Pickering emulsions, hydrodispersions, or lipodispersions. The flowable formulations are preferably emulsions, suspensions, colloids, dispersions, gels, or solutions.

Technically, gels are: readily deformable disperse systems comprising at least two components and having a degree of dimensional stability, generally composed of a—mostly solid—colloidally dispersed substance composed of long-chain molecular groups (e.g. gelatin, silica, polysaccharides) as structure-former, and of a liquid dispersion medium (e.g. water). The colloidally dispersed substance is often termed thickener or gelling agent. It forms a three-dimensional network in the dispersion medium, and there may be some degree of bonding here between individual colloidal particles by way of electrostatic interaction. The dispersion medium which surrounds the network has electrostatic affinity to the gelling agent, so that a predominantly polar (in particular: hydrophilic) gelling agent preferably gels a polar dispersion medium (in particular: water), and in contrast a predominantly non-polar gelling agent preferably gels non-polar dispersion media.

Strong electrostatic interactions, for example those arising when there are hydrogen bonds between gelling agent and dispersion medium, or else between molecules of dispersion medium themselves, can also lead to a high degree of crosslinking of the dispersion medium. Hydrogels may be composed of almost 100% of water (with from about 0.2 to 1.0% of a gelling agent, for example) while having a very firm consistency. The water content here is present in the form of structural units similar to those in ice.

Lipogels and oleogels (composed of waxes, fats, or fixed oils) are familiar in cosmetics and pharmaceuticals, as are carbogels (composed of paraffin or petrolatum). In the industry a distinction is made between oleogels, which are practically water-free, and hydrogels, which are practically fat-free. Gels are mostly transparent. Gels in cosmetics and pharmaceuticals very generally have a semisolid consistency, which is often flowable.

Surfactant gels are other familiar preparations of the prior art. These are systems which comprise water with a high concentration of emulsifiers, typically more than about 25% by weight, based on the entire composition. If oil components are solubilized into these surfactant gels the result is microemulsion gels, also termed “ringing gels”. Cosmetically more elegant microemulsion gels can be obtained by adding non-ionic emulsifiers, for example alkyl polyglycosides.

Emulsions are metastable two- or multiphase systems in which each of the phases present is a liquid. The most commonly encountered emulsions are OW and W/O emulsions. Multiple emulsions are less commonly found, these being those in which droplets of another dispersed phase are in turn present within the droplets of the dispersed (or discontinuous) phase, examples being W/O/W emulsions and O/W/O emulsions. Simple emulsions have finely dispersed droplets of the second phase (water droplets in W/O emulsions or lipid vesicles in O/W emulsions) surrounded by an emulsifier envelope within the first phase. The droplet diameters in the usual emulsions are in the range from about 1 μm to about 50 μm. Without addition of colorant additives, these “macroemulsions” have a milky white color and are opaque. Finer “macroemulsions” with droplet diameters in the range from about 10⁻¹ μm to about 1 um have a bluish-white color and are non-transparent, again without any colorant additives. Micellar and molecular solutions with particle diameters smaller than about 10-2 μm have a clear and transparent appearance.

In contrast, the droplet diameter in transparent or translucent microemulsions is in the range from about 10⁻² μm to about 10⁻¹ μm. These microemulsions mostly have low viscosity. The viscosity of many O/W-type microemulsions is comparable with that of water.

Emulsions are by far the most important type of product in the skin-care sector, or in the sector of cosmetic and/or dermatological preparations. Emulsions are disperse two- or multiphase systems, and cosmetic emulsions are composed of at least one fatty phase (fats and mineral oils, fatty esters, fatty alcohols, etc.) and of at least one aqueous phase (water, glycerine, glycols, etc.), these being distributed within one another in the form of very fine droplets with the aid of emulsifiers. If the two liquids are water and oil, and if there are oil droplets finely distributed in water, the material is an oil-in-water emulsion (O/W emulsion, an example being milk). The underlying character of an O/W emulsion is determined by the water. In the case of a water-in-oil emulsion (W/O emulsion, an example being butter), the reverse principle applies, the underlying character here being determined by the oil.

The oil phase is advantageously selected from the group of the esters of saturated and/or unsaturated, branched and/or unbranched alkanecarboxylic acids and saturated and/or unsaturated, branched and/or unbranched alcohols, from the group of the esters of aromatic carboxylic acids and saturated and/or unsaturated, branched and/or unbranched alcohols, from the group of the branched or unbranched hydrocarbons and hydrocarbon waxes, silicone oils, dialkyl ethers, the group of the saturated or unsaturated, branched or unbrancbed alcohols, or else the triglycerides of the fatty acids. For the purposes of the present invention, it is also advantageous to use any desired blend of these oil components and wax components. Where appropriate, advantageous use may also be made of waxes, such as cetyl palmitate, as sole lipid component of the oil phase.

The oil phase may advantageously have some content of cyclic or linear silicone oils, such as cyclomethicone (octamethylcyclotetrasiloxane), or be composed entirely of those oils, but it is preferable to use some additional content of other oil-phase components besides the silicone oil or the silicone oils. The emulsions described here and below can therefore be manufactured in the form of silicone emulsions, with partial or sole use of silicone oils. The same applies to the other oil-containing preparations.

The skilled worker is aware of a wide variety of possibilities for formulating stable O/W preparations for cosmetic or dermatological use, e.g. in the form of creams and ointments which are spreadable in the range from room temperature to skin temperature, or in the form of lotions and milks which are more flowable in this range of temperature and can be stored particularly advantageously using the container of the invention.

The stability of emulsions depends, inter alia, on their viscosity, in particular on the viscosity of the external phase. An emulsion becomes unstable if the finely dispersed particles accumulate again to give relatively large aggregates, and the droplets coalesce when they contact one another. This process is termed coalescence. The more viscous the external phase of the emulsion, the slower the coalescence process.

O/W emulsions are therefore generally stabilized by thickeners which increase the viscosity of the aqueous phase. Examples of materials suitable for this purpose are polyacrylates (carbomer) and other organic thickeners. One disadvantage of this method of improving stability is the sensitivity of these formulations toward electrolytes. This method moreover naturally produces formulations (such as creams or ointments) mainly of relatively high viscosity.

Emulsions with “liquid” (=flowable) consistency are used in cosmetics, for example as beauty lotion, cleansing lotion, facial lotion, or hand lotion. Their viscosity is generally from about 2 000 mPa·s to about 10 000 mPa·s. The stability of flowable emulsions requires particular attention, since the particles have considerably more freedom of motion, promoting more rapid coalescence.

Conventional emulsifiers can be subdivided into ionic (anionic, cationic, and amphoteric) and non-ionic on the basis of the hydrophilic moiety in their molecule. Probably the best known example of an anionic emulsifier is soap, this being the term usually used for the water-soluble sodium salts or potassium salts of the higher saturated or unsaturated fatty acids.

Important cationic emulsifiers are the quaternary ammonium compounds. The hydrophilic moiety in the molecule of non-ionic emulsifiers is often composed of glycerine, polyglycerine, sorbitans, or carbohydrates, or polyoxyethylene glycols, mostly linked to the lipophilic moiety in the molecule by way of ester bonds and ether bonds. The lipophilic moiety is usually composed of fatty alcohols, fatty acids, or isofatty acids. The lipophilic and hydrophilic properties of emulsifiers can be modified within wide limits by varying the structure and the size of the polar and of the non-polar moiety in the molecule.

A decisive factor for the stability of an emulsion is the correct selection of the emulsifiers. The characteristics of all of the substances present in the system have to be considered here. For example, in skin-care emulsions polar oil components and, for example, UV filters cause instability. Alongside the emulsifiers, use is therefore made of other stabilizers which increase the viscosity of the emulsion and/or act as a protective colloid.

There are no risks involved per se with the use of conventional emulsifiers in cosmetic or dermatological preparations. However, in particular cases emulsifiers can bring about allergic reactions or reactions due to hypersensitivity of the user, as indeed can any chemical substance. There have therefore been many attempts to reduce the amount of conventional emulsifiers to a minimum, or ideally eliminate these entirely.

One way of reducing the amount of emulsifier needed is to utilize the fact that very finely dispersed particles of solid have an added stabilizing action. The solid substance here becomes concentrated in the form of a layer at the oil/water phase boundary, thereby inhibiting coalescence of the disperse phases. It is the surface properties of the solid particles rather than the chemical properties which are of substantial importance here.

A relatively new technical development stabilizes cosmetic or dermatological preparations solely via very finely dispersed solid particles. These “emulsifier-free” emulsions are named for their inventor Pickering emulsions. According to May-Alert (Pharmazie in unserer Zeit, volume 15 1986, No. 1, 1-7), an example of a method for solids-stabilization in a cosmetic or dermatological preparation is to use emulsifier mixtures which comprise both anionic and cationic surfactants. Since combining anionic and cationic surfactants always leads to precipitation of insoluble compounds with no electrical charge, controlled precipitation of these neutral surfactants at the oil/water interface can achieve additional Pickering-emulsion-type solids-stabilization.

WO 98/42301 A1 moreover describes emulsifier-free finely dispersed systems of water-in-oil type which are stabilized by addition of micronized inorganic pigments, these being selected from the group of the metal oxides, in particular titanium dioxide.

Emulsifier-free preparations based on what are known as hydrodispersions have been available to the consumer for some time. Hydrodispersions are dispersions of a liquid, semisolid, or solid internal (discontinuous) lipid phase in an external aqueous (continuous) phase.

In contrast to O-W emulsions, which nevertheless have a similar arrangement of phases, hydrodispersions are substantially free from emulsifiers. Like emulsions, hydro-dispersions are metastable systems with a tendency to convert into a condition with two coherent discrete phases. In emulsions, the selection of a suitable emulsifier inhibits phase separation.

In the case of hydrodispersions of a liquid lipid phase in an external aqueous phase, the stability of this system can, for example, be ensured by constructing, within the aqueous phase, a gel structure in which the lipid droplets have been stably suspended. By reverse analogy, W/O lipodispersions are finely dispersed emulsifier-free preparations of water-in-oil type. The invention also provides the use of a container in combination with cosmetic or dermatological preparations in the form of gels, emulsions, microemulsions, suspensions, dispersions, colloids, powders, and/or pastes.

Combination of the container of the invention with liquid cosmetic cleansing compositions which, by virtue of the specific container, can be used for cleansing with a massaging effect, is particularly advantageous. Liquid cosmetic cleansing compositions are known per se. The invention therefore provides the combination of these compositions with a packaging which permits the application of the cleansing composition with a massaging effect.

Liquid cosmetic cleansing compositions include all of the formulations with anionic, cationic, non-ionic, or amphoteric, or zwitterionic, surfactants. Skin-care substances may also be present in these formulations. Skin-care substances which may be used are refatting agents, conditioners, peeling agents, or active ingredients.

A particular advantage of this packaging is that the massager is easy to clean, since the specific construction permits unhindered passage of water through the passages. There is therefore no need for a high concentration of preservative in the cleansing composition. Another result is that microbiological safety of the product is ensured.

The specific construction of the massagers permits pure pressure massage, thus preventing irritation of the skin due to excessive rubbing on the surface of the skin. This method provides a very gentle means of using the cleansing compositions. During massage there is less irritation of the skin due to the use of a cleansing composition.

Five examples below are examples of cosmetic cleansing compositions for which the container of the invention can be used with excellent results.

### EXAMPLES OF COSMETIC CLEANSING COMPOSITIONS

### Example 1

| | % by weight |
|---|---|
| Sodium laureth sulfate | 9.00 |
| Cocamidopropyl betaine | 4.00 |
| Decyl glucoside | 1.00 |
| Glycol distearate | 2.00 |
| Sodium cocoyl glutamate | 0.30 |
| Fragrance | 0.80 |
| Prunus ducis | 0.20 |
| Water ad | 100.00 |

### Example 2

| | % by weight |
|---|---|
| Sodium laureth sulfate | 9.00 |
| Cocamidopropyl betaine | 4.00 |
| Decyl glucoside | 1.00 |
| Sodium cocoyl glutamate | 0.30 |
| Fragrance | 1.00 |
| Vitis vinifera | 1.00 |
| Aloe barbensis | 1.00 |
| Polyquaternium-10 | 0.30 |
| Water ad | 100.00 |

### Example 3

| | % by weight |
|---|---|
| Sodium laureth sulfate | 12.00 |
| Cocamidopropyl betaine | 3.00 |
| Sodium lauroyl sarcosinate | 2.00 |
| PEG-4 rapeseedamide | 5.00 |
| PEG-9 cocoglycerides | 2.00 |
| Fragrance | 1.00 |
| Hydroxypropyl guar | 0.30 |
| Hydroxypropyltrimonium chloride | |
| Water ad | 100.00 |

### Example 4

| | % by weight |
|---|---|
| MIPA-laureth sulfate (+) laureth-4 | 41.00 |
| cocamide DEA | |
| Soybean oil | 40.00 |
| Castor oil | 14.00 |
| Polxamer 10 1 | 4.00 |
| Fragrance | 2.00 |
| Panthenol | 1.00 |
| Water ad | 100.00 |

### Example 5

| | % by weight |
|---|---|
| Sodium laureth sulfate | 10.00 |
| Polyethylene | 5.00 |
| Sodium cocamphoacetate | 4.00 |
| Magnesium aluminum silicate | 3.00 |
| Sodium cocoyl glutamate | 1.00 |
| Fragrance | 0.80 |
| Water ad | 100.00 |

Besides the advantages described above, the containers of the invention have an additional advantage for the user in the body-care sector, due to the massage effect brought about by the modified surface. During application of cosmetic or dermatological preparations, a simultaneous positive effect can be achieved, for example for skin firming or to counter cellulitis.

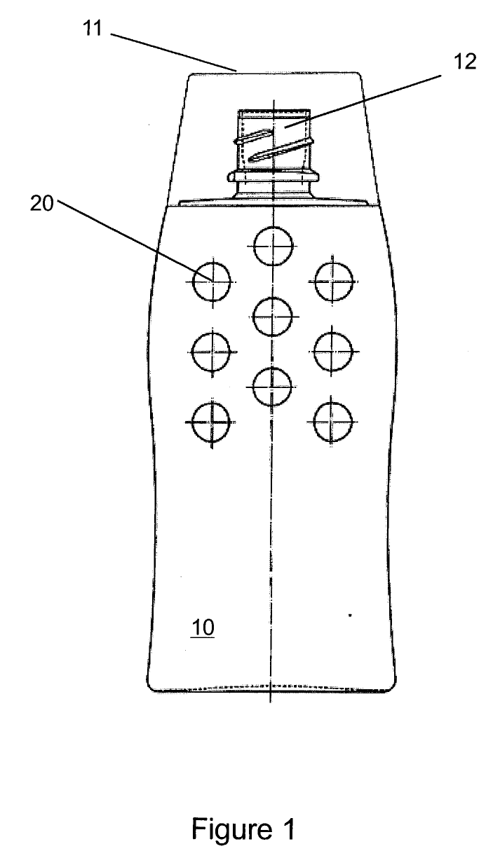

Turning now to the Figures, FIG. 1 illustrates the front view of a particularly advantageously designed container 10 in bottle form. The bottle 10, produced by extrusion blow molding, is substantially rectangular in form, but the edges of the bottle 10 have been rounded. On the body of the bottle 10 there is a neck-type extension 12, serving for dispensing of the contents. A lid 11 has been placed on the bottle 10 and at the same time closes the extension 12.

In one of the wider side walls of the bottle 10 there are a number of devices 20 which together form massage equipment. The devices 20 here have the form of spheres, and have been mounted rotatably in sockets in the wall.

The devices 20 form a regular pattern composed of a total of nine spheres. The pattern or the number of spheres in the pattern is freely selectable, depending on the application or contents of the bottle 10. The same also applies to the size of the devices located in the container.

The user of the contents of the bottle 10 can use slight pressure on the bottle 10 to remove some of the contents and, for example, apply the same to the skin. The user can then use the massage equipment to massage the applied contents conveniently into the skin, without having to pick up or search for any additional apparatus.

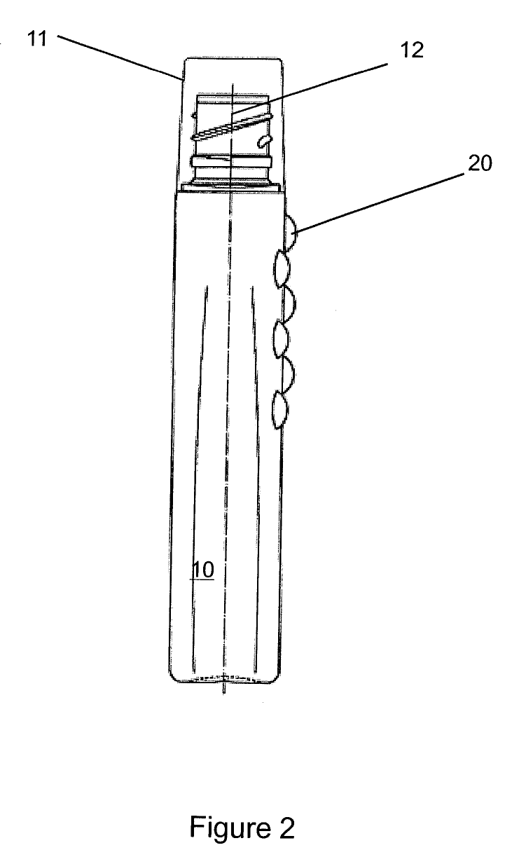

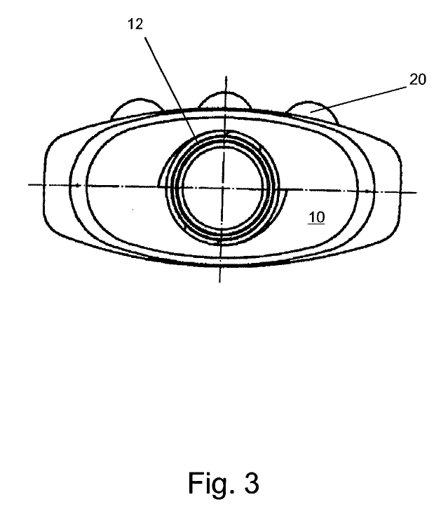

FIGS. 2 and 3 show the side view and, respectively, the plan view of the bottle.

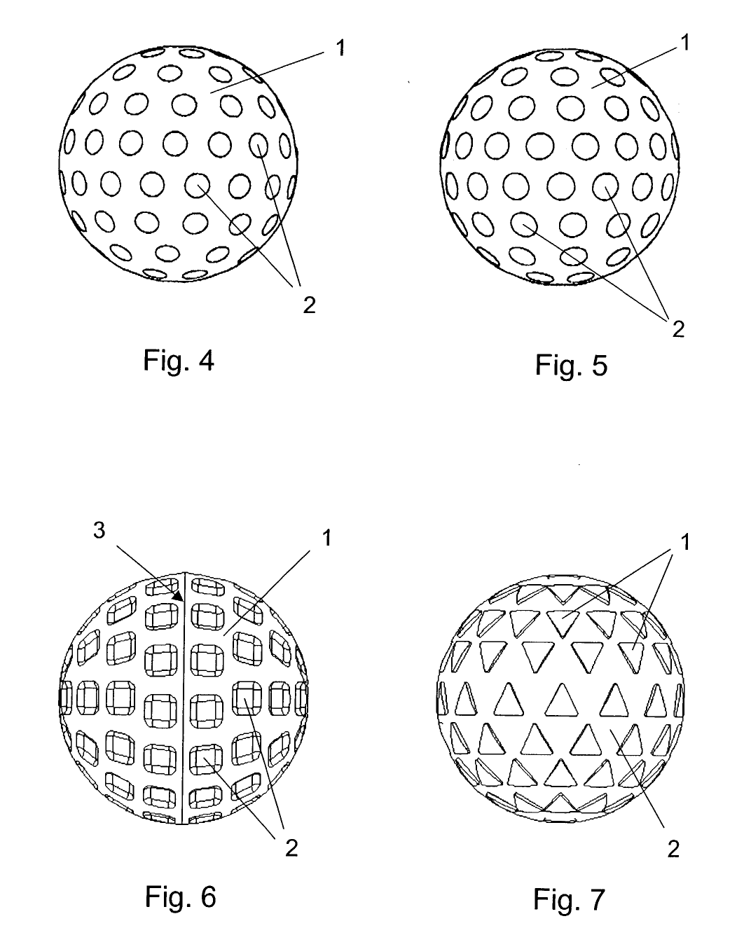

FIGS. 4-7 illustrate by way of example four different embodiments of the device, in each case here in the form of a sphere. Each figure illustrates the level surface 1 of the sphere, which can be regarded as the macroscopic surface of the sphere, and also illustrates the depressions 2 within this level surface.

In FIGS. 4-6, these depressions 2 are separate from one another, and specifically have the shape of circular seatinges (FIGS. 4 and 5, different arrangements of the depressions 2), or square depressions (FIG. 6). FIG. 6 also illustrates the weld line 3 produced by injection molding in a two-part mold or during build-up of the sphere from two sphere halves.

FIG. 7 shows a spherical device with a system composed of connected channel-type type depressions 2 in the surface 1 (“open-pore system”). Seen in another way, the (in this example triangular) regions 1 represent elevations on the sphere formed by the “flat channel surfaces” 2.

What is claimed is:

1. A container comprising:
a container body defining: (A) a seating for receiving at least a portion of a rotatable device, (B) a product storage portion that is configured for receiving a product to be stored within said container, and (c) a neck type extension for dispensing said product from said container; and
a rotatable device that is disposed at least partially within said seating so that a first portion of said rotatable device is within said seating, and so that a second portion of said rotatable device extends outside of said seating, wherein
said rotatable device is mounted to rotate relative to said container body.

2. The container of claim 1, wherein said rotatable device is mounted to rotate about at least one axis of rotation.

3. The container of claim 1, wherein:
said seating is a first seating;
said rotatable device is a first rotatable device;
said container body defines a second seating for receiving a portion of a second rotatable device, said container comprises a second rotatable device that is disposed at least partially within said second seating so that a first portion of said second rotatable device is within an interior portion of said second seating, and so that a second portion of said second rotatable device extends outside of said second seating; and
said second rotatable device is mounted to rotate relative to said container body.

4. The container of claim 1, wherein an exterior surface of said rotatable device defines a symmetrical arrangement of depressions.

5. The container of claim 1, wherein said rotatable device is spherical.

6. The container of claim 1, wherein said rotatable device comprises a roller.

7. The container of claim 1, wherein said container body is configured to receive said rotatable device into said seating and to hold said rotatable device in place in a “snap fit” manner.

8. A container comprising:
a container body defining: (A) a seating for receiving at least a portion of a rotatable device, and (B) a product storage portion that is configured for receiving a product to be stored within said container; and
a rotatable device that is disposed at least partially within said seating so that a first portion of said rotatable device is within said seating, and so that a second portion of said rotatable device extends outside of said seating,
wherein said rotatable device is mounted to rotate relative to said container body about an axis of rotation.

9. The container of claim 8, wherein said rotatable device comprises a roller.

10. The container of claim 8, wherein said rotatable device is in the shape of a cone.

11. A method of dispensing and applying a product, said method comprising the steps of:
providing a container that is filled at least partially with said product and that comprises at least one rotatable device that is disposed adjacent an exterior surface of said container, said container comprising a neck type extension for dispensing said product from said container;
dispensing a portion of said product from said outlet onto a user's skin; and
using said at least one rotatable device to distribute said product relative to said user's skin.

12. The method of claim 11, wherein said container comprises a plurality of rotatable devices.

13. A method of dispensing and applying a product, said method comprising the steps of:
providing a container that is filled at least partially with said product and that comprises at least one rotatable device that is disposed adjacent an exterior surface of said container, said rotatable device being configured to rotate about an axis of rotation;
dispensing a portion of said product from said container onto a user's skin; and
using said at least one rotatable device to distribute said product relative to said user's skin.

14. The method of claim 13, wherein said step of using said at least one rotatable device to distribute said product comprises causing said at least one rotatable device to rotate about said axis of rotation.

15. The method of claim 13, wherein said container comprises a plurality of rotatable devices.
